(19) United States
(12) Patent Application Publication
(10) Pub. No.: US 2016/0234507 A1
(43) Pub. Date: Aug. 11, 2016

(54) IMAGE TRANSMISSION SYSTEM

(71) Applicant: NTT Resonant Technology Inc., Tokyo (JP)

(72) Inventor: Koji Hisano, Tokyo (JP)

(21) Appl. No.: 14/362,817

(22) PCT Filed: Nov. 1, 2013
(86) PCT No.: PCT/JP2013/079706

§ 371 Date: Jun. 4, 2014

(51) Int. Cl. H04N 19/156

(52) U.S. Cl. CPC H04N 19/156

(57) ABSTRACT

A first compressed image data is generated in a smart phone 10 and it is decided whether a first hash value calculated therefrom is stored in a server device 20 or not. Only if the first hash value is not stored, the first compressed image data and the first hash value are transmitted to the server device 20 and are stored therein. Furthermore, a second compressed image storing section is generated from the first compressed image data in the server device 20 and it is decided whether a second hash value calculated therefrom is stored in a client device 30 or not. Only if the second hash value is not stored, the second compressed image data and the second hash value are transmitted to the client device 30 and are stored therein. Consequently, processing for determining whether to transmit image data and processing for compressing image data are set to be carried out over two stages respectively, thereby enabling a response time to be shortened as greatly as possible till acquirement of the image data after the client device 30 gives an image acquirement request.

### TECHNICAL FIELD

The present invention relates to an image transmission system, and more particularly, is suitably used for an image transmission system serving to transmit image data generated by an image generation device in response to an image acquirement request output from a client device from a server device to the client device.

### BACKGROUND ART

Conventionally, there is widely offered a system in which a client device is connected to a server device through a communication network such as internet to carry out data communication between the client device and the server device. For example, there is a system for generating image data in a server device based on an image acquirement request when the request is transmitted from a client device to the server device and transmitting the generated image data to the client device and displaying the image data thereon.

The image data to be transmitted from the server device to the client device has a large data volume. For this reason, a load of a communication network is increased so that data transmission takes a long time. Therefore, it is demanded to shorten a time taken for the data transmission, and various techniques therefor are thus provided. For instance, there is the technique for compressing image data to be transmitted (for example, see Patent Document 1). Moreover, there is also the technique for controlling whether to transmit image data by using a hash value (for example, see Patent Document 2).

Both of the techniques described in the Patent Documents 1 and 2 relate to techniques devised in consideration of the case in which the same image data is repetitively transmitted.

### Patent Document 1: Japanese Laid-Open Patent Publication No. 2009-212748

### Patent Document 2: Japanese Laid-Open Patent Publication No. 2007-201861

In other words, the image compression device described in the Patent Document 1 accepts the image information transmitted from the server device and stores an acceptance frequency of the image information. The image compression device performs a hash operation for the accepted image information to generate a hash value. Then, it is retrieved whether an identical hash value is present in “hash value” of the hash saving RAM. If it is decided that the identical hash value is present, “frequency” of the hash saving RAM which indicates the number of times of the acceptance for the image information is counted up. On the other hand, if it is decided that the identical hash value is not present, the generated hash value is stored in the “hash value” of the hash saving RAM and “1” is stored in the “frequency” because the image information is accepted for the first time.

Moreover, the image compression device compresses image information and stores and outputs the compressed image information. The server device transmits the compressed image information to the client device. The image compression device repetitively compresses the compressed image information corresponding to image information having a high frequency while the image information is not accepted by the server device, and stores the compressed image information as recompressed image information. The image compression device fetches and outputs the recompressed image information corresponding to the image information when newly accepting the image information from the server device, and the server device transmits the recompressed image information to the client device.

Referring to the camera system described in the Patent Document 2, moreover, in the case in which the image file is transferred from the camera to the server, it is previously decided whether both of them have the same image file or not. When coincidence of the image files is to be decided, partial hash values summarizing head portions of the image files are calculated and compared with each other. If the partial hash values are coincident with each other, full hash values summarizing the whole image files are further calculated and compared with each other. The image files having all of the partial hash values and the full hash values which are coincident with each other are decided as identical files. On the other hand, the image file having one of them which is not coincident is decided as another file and a request for transmitting the image file is given to the camera.

In recent years, a smart phone spreads rapidly in place of a portable telephone of a conventional type. As one of attractions of the smart phone, a user can freely download and utilize various applications (which will be hereinafter referred to as smart phone applications).

However, a great variety of OS, for example, Android (registered trademark), iPhone iOS (iPhone is registered trademark), BlackBerry OS (BlackBerry is registered trademark), Windows Phone 8 (Windows Phone is registered trademark) or the like is provided on a smart phone and machine types are increased more and more than before. The environment causes troubles for suppliers who are engaged in development or verification of the smart phone applications. If they purchase all of machine types every release, a cost is excessively increased.

In consideration of the actual circumstances, a rental service for a smart phone is provided. A rental type includes a type for lending an actual machine of a smart phone to application developers, a type for enabling a smart phone to be utilized in a rental room, and furthermore, a type (a remote rental service) for enabling a smart phone to be utilized by giving remote access via internet.

Referring to the remote rental service, there is provided a function for specifying a desirable smart phone application to carry out remote installation into a smart phone, thereby performing remote control such as execution of various commands or debugging. As one of functions which can be executed by the remote control, there is provided a function for carrying out camera photographing by a smart phone to transmit the photographed image. By utilizing the function, it is possible to verify whether the photographing is carried out without problems or not. Moreover, there is also provided a function for causing a screen of the smart phone to make a transition by remote control, thereby acquiring and transmitting a captured image of each screen. By utilizing the function, it is possible to verify whether the screen transition is made without problems or whether the smart phone application is normally operated or not.

In the case in which the remote rental service is offered, it is necessary to have a large number of smart phones which are compatible with each OS and each machine type and a server device connected to these smart phones by wireless or cable, and to transmit image data generated by the smart phones from the server device to a client device via internet. In this case, it is desired to shorten a response time till transmission of corresponding image data from the server device when remote control related to image acquirement of the smart phone is carried out by the client device.

### DISCLOSURE OF THE INVENTION

In consideration of the actual circumstances, it is an object of the present invention to enable a response time to be shortened as greatly as possible till acquirement of image data after a client device gives an image acquirement request in a system for transmitting image data generated by an image generation device such as a smart phone from a server device to the client device.

In order to attain the object, in the present invention, the image generation device generates first compressed image data and it is decided whether a feature amount capable of specifying identity of the first compressed image data is stored in a server device or not. Only if the feature amount is not stored, the first compressed image data and the feature amount are transmitted to the server device and is stored therein. In addition, in the present invention, the server device generates second compressed image storing section from the first compressed image data and it is decided whether a feature amount capable of specifying identity of the second compressed image data is stored in a client device or not. Only if the feature amount is not stored, the second compressed image data and the feature amount are transmitted to the client device and are stored therein.

According to the present invention having the structure described above, in the case in which acquirement of image data transmitted once from the image generation device to the server device is required again, the image data is prevented from being transmitted again from the image generation device to the server device based on the decision using the feature amount. In the case in which the acquirement of the image data transmitted once from the server device to the client device is required again, similarly, the image data is prevented from being transmitted again from the server device to the client device based on the decision using the feature amount. Consequently, it is possible to avoid waste, that is, the repetition transmission of the same image data over two stages between the image generation device and the server device and between the server device and the client device. Thus, it is possible to omit a time taken for the data transmission.

According to the present invention, moreover, the image data are compressed over two stages including the image generation device and the server device. Even if the image data is transmitted, therefore, it is possible to considerably reduce a data volume of the image data to be transmitted. Consequently, it is possible to shorten a time required for the data transmission. As described above, the processing for determining whether to transmit the image data and the processing for compressing the image data are carried out over the two stages, respectively. Thus, it is possible to shorten a response time as greatly as possible till acquirement of the image data after the client device gives an image acquirement request.

### BRIEF DESCRIPTION OF THE DRAWINGS

FIG. 1 is a diagram showing an example of a whole structure of an image transmission system according to the present embodiment.

FIG. 2 is a block diagram showing an example of a functional structure of a smart phone (an image generation device) according to the present embodiment.

FIG. 3 is a block diagram showing an example of a functional structure of a server device according to the present embodiment.

FIG. 4 is a block diagram showing an example of a functional structure of a client device according to the present embodiment.

FIG. 5 is a flowchart showing an example of an operation of the image transmission system according to the present embodiment.

FIG. 6 is a block diagram showing another example of a functional structure of a server device according to the present embodiment.

FIG. 7 is a block diagram showing yet another example of the functional structure of the server device according to the present embodiment.

FIG. 8 is a block diagram showing a further example of the functional structure of the server device according to the present embodiment.

### BEST MODE FOR CARRYING OUT THE INVENTION

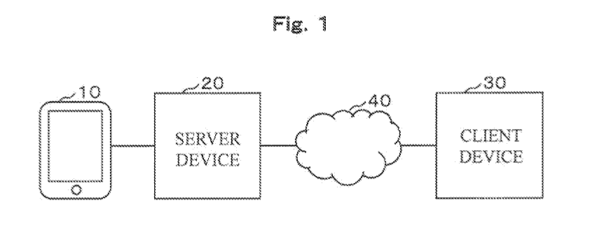

An embodiment according to the present embodiment will be described below with reference to the drawings. FIG. 1 is a diagram showing an example of a whole structure of an image transmission system according to the present embodiment. As shown in FIG. 1, the image transmission system according to the present embodiment includes an image generation device 10, a server device 20 connected to the image generation device 10 through a local area network (LAN), and a client device 30 connected to the server device 20 through a wide area network (WAN) such as internet 40.

The image generation device 10 is configured from a smart phone, for example. The smart phone 10 has a function for carrying out camera photographing and a function for capturing a screen which is being displayed and can generate image data by using these functions. The image transmission system according to the present embodiment serves to carry out the camera photographing or the screen capture by means of the smart phone 10 in response to an image acquirement request output from the client device 30 and to transmit image data thus generated from the server device 20 to the client device 30.

The camera photographing and the screen capture in the smart phone 10 may be carried out only once for a single image acquirement request output from the client device 30 or may be continuously performed for the single image acquirement request plural times. In the latter case, the server device 20 sequentially transmits, to the client device 30, a plurality of image data generated by the smart phone 10 in response to the single image acquirement request output from the client device 30.

In the case in which a plurality of image data is transmitted in response to the single image acquirement request, processing may be ended when transmission of a predetermined number of image data which is indicated by the image acquirement request is completed or the processing may be continuously carried out until a processing stop instruction is subsequently output from the client device 30. Alternatively, the processing may be continuously carried out until the server device 20 and the client device 30 are disconnected from each other.

Although the connection between the smart phone 10 and the server device 20 is shown with simplification, they are connected to each other through a LAN cable, a USB cable or the like. Alternatively, a wireless access point may be provided between the smart phone 10 and the server device 20 to connect the smart phone 10 and the wireless access point by wireless. In the present embodiment, a connection configuration between the smart phone 10 and the server device 20 is not restricted.

The image transmission system according to the present embodiment can be utilized for a remote rental service for the smart phone 10. In this case, a plurality of smart phones 10 is actually connected to the serer device 20. Moreover, access is given from the optional client device 30 on the internet 40 so that the server device 20 is connected. In other words, the optional client device 30 and the optional smart phone 10 are connected to each other through the server device 20.

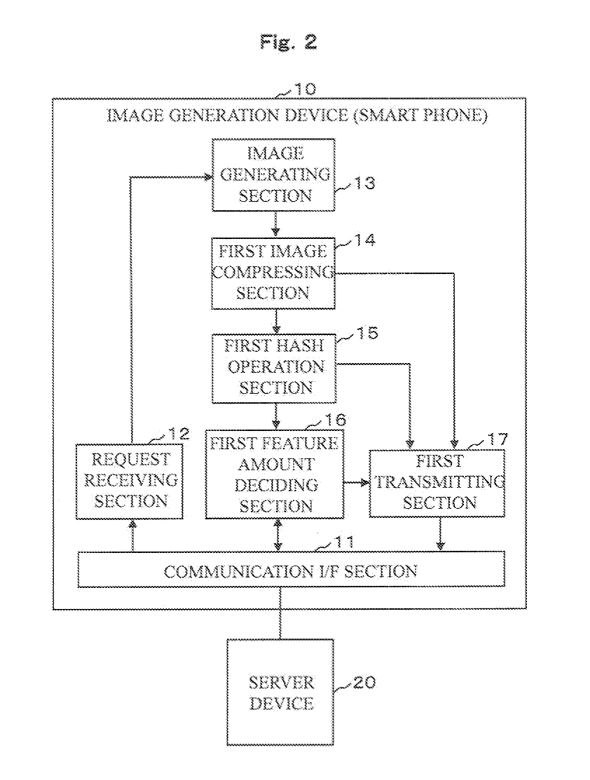

FIG. 2 is a block diagram showing an example of a functional structure of the smart phone 10 according to the present embodiment. As shown in FIG. 2, the smart phone 10 according to the present embodiment includes, as a functional structure thereof, a communication I/F section 11, a request receiving section 12, an image generating section 13, a first image compressing section 14, a first hash calculating section 15, a first feature amount deciding section 16 and a first transmitting section 17.

Each of the function blocks 11 to 17 can be configured by hardware, DSP (Digital Signal Processor) or software. For example, in the case in which they are configured by the software, each of the function blocks 11 to 17 actually includes a CPU, an RAM and an ROM in a computer and the like and a program stored in a recording medium such as the RAM, the ROM, a hard disk or a semiconductor memory is operated so that implementation can be performed.

The communication I/F section 11 serves to carry out communication with the server device 20. The request receiving section 12 receives an image acquirement request transmitted from the client device 30 through the internet 40 and the server device 20. The image acquirement request is a remote operation signal for giving a request for carrying out camera photographing through the smart phone 10 to acquire the photographed image. Alternatively, the image acquirement request is a remote operation signal for causing a screen of the smart phone 10 to make a transition and acquiring a captured image on the screen subjected to the transition.

The image generating section 13 perform the camera photographing or the screen capture to generate image data in response to the image acquirement request received by the request receiving section 12. The first image compressing section 14 compresses the image data generated by the image generating section 13 to generate first compressed image data.

In the case in which the image transmission system is utilized for the remote rental service for the smart phone 10 as in the present embodiment, it is preferable to carry out the image compression by using a function which is usually possessed by the smart phone 10. Moreover, the smart phone 10 has a lower throughput than the server device 20. For this reason, it is preferable to carry out the image compression by a method having a comparatively small processing load. For example, the first image compressing section 14 compresses image data by a JPEG method.

In some cases in which an image making a screen transition is sequentially captured, particularly, the smart phone 10 is caused to execute a specific command to capture the image making the screen transition, only a part in the screen is changed before and after the transition and the other parts are not changed. Therefore, the first image compressing section 14 may extract a difference from image data before the screen transition and compress only the difference data by the JPEG when compressing the captured image subjected to the screen transition.

The first hash operation section 15 performs a hash operation over the first compressed image data generated by the first image compressing section 14 and calculates a first hash value as a feature amount which can be specified identity of the first compressed image data. Referring to the hash operation itself, it is possible to apply a well-known method.

The first feature amount deciding section 16 decides whether the first hash value calculated by the first hash operation section 15 is stored in the server device 20 or not. Specifically, the first feature amount deciding section 16 transmits the first hash value calculated by the first hash operation section 15 to the server device 20 through the communication I/F section 11 and makes an inquiry as to whether the same hash value as the first hash value is stored in the server device 20 or not. Based on a response content transmitted from the server device 20 as a result, then, it is decided whether the first hash value is stored in the server device 20 or not. Thereafter, a notice of a result of the decision is given to the first transmitting section 17.

Only if the first feature amount deciding section 16 decides that the first hash value is not stored in the server device 20, the first transmitting section 17 transmits the first compressed image data and the first hash value to the server device 20 through the communication I/F section 11. When the first feature amount deciding section 16 makes an inquiry, the first hash value has already been transmitted. For this reason, only the first compressed image data may be transmitted additionally.

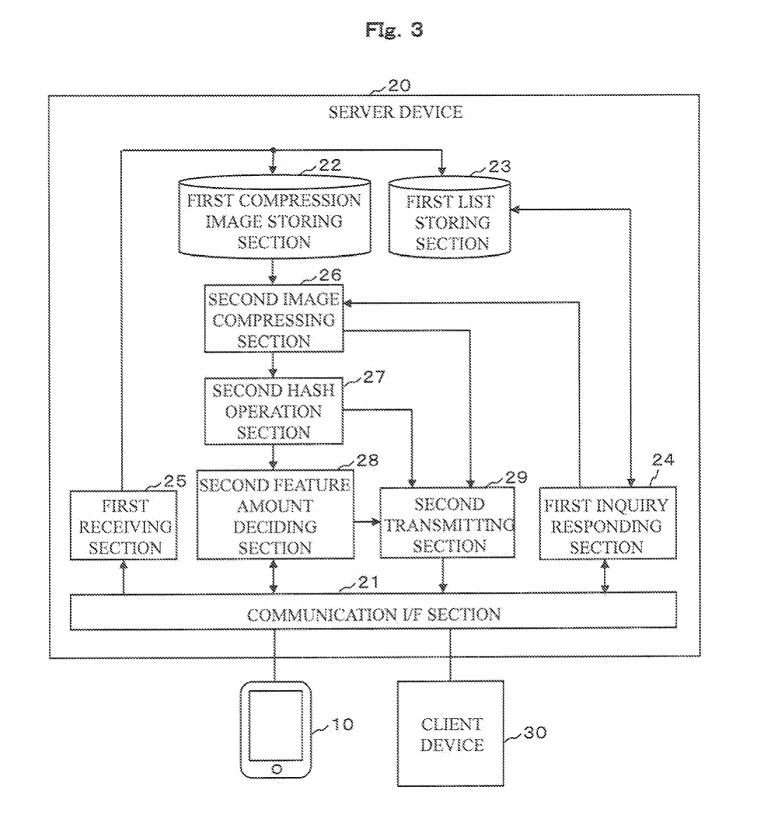

FIG. 3 is a block diagram showing an example of a functional structure of the server device 20 according to the present embodiment. As shown in FIG. 3, the server device 20 according to the present embodiment includes, as a functional structure thereof, a communication I/F section 21, a first compressed image storing section 22, a first list storing section 23, a first inquiry responding section 24, a first receiving section 25, a second image compressing section 26, a second hash operation section 27, a second feature amount deciding section 28 and a second transmitting section 29.

Each of the function blocks 21 and 24 to 29 can be configured by hardware, DSP or software. For example, in the case in which they are configured by the software, each of the function blocks 21 and 24 to 29 actually includes a CPU, an RAM and an ROM in a computer and the like and a program stored in a recording medium such as the RAM, the ROM, a hard disk or a semiconductor memory is operated so that implementation can be performed.

The communication I/F section 21 serves to carry out communication between the smart phone 10 and the client device 30. The first compressed image storing section 22 stores the first compressed image data transmitted by the first transmitting section 17 of the smart phone 10. The first list storing section 23 stores, as a first hash list, the first hash value transmitted by the first transmitting section 17.

The first inquiry responding section 24 carries out processing for responding to an inquiry transmitted from the first feature amount deciding section 16 of the smart phone 10. In other words, the first inquiry responding section 24 receives the first hash value transmitted from the first feature amount deciding section 16 and confirms whether the first hash value has already been stored in the first list storing section 23. Then, a result of the confirmation as to whether the first hash value is stored is returned to the first feature amount deciding section 16 of the smart phone 10. Moreover, the first inquiry responding section 24 gives a notice of the result of the confirmation to the second image compressing section 26.

The first receiving section 25 receives the first compressed image data and the first hash value which are transmitted from the first transmitting section 17 of the smart phone 10. Then, the first receiving section 25 stores the first compressed image data in the first compressed image storing section 22, and furthermore, stores the first hash value in the first list storing section 23. At this time, the first compressed image data and the first hash value are stored in such a configuration that their association is apparent.

The second image compressing section 26 compresses the first compressed image data stored in the first compressed image storage section 22 to generate second compressed image data. Specifically, the second image compressing section 26 reads the relevant first compressed image data from the first compressed image storing section 22 to carry out compression processing depending on a content of a confirmation result given from the first inquiry responding section 24.

In other words, if the first inquiry responding section 24 confirms that the first hash value transmitted from the first feature amount deciding section 16 of the smart phone 10 is not stored in the first list storing section 23, the first compressed image data and the first hash value are transmitted from the first transmitting section 17 of the smart phone 10 immediately thereafter and are stored in the first compressed image storing section 22 and the first list storing section 23. In this case, the second image compressing section 26 compresses the first compressed image data stored newly in the first compressed image storing section 22 to generate second compressed image data. The second image compressing section 26 may directly acquire the first compressed image data received by the first receiving section 25, thereby carrying out the compression processing.

On the other hand, if the first inquiry responding section 24 confirms that the first hash value transmitted from the first feature amount deciding section 16 of the smart phone 10 has already been stored in the first list storing section 23, it is apparent that the first compressed image data corresponding to the first hash value has already been stored in the first compressed image storing section 22. In this case, the second image compressing section 26 reads the first compressed image data stored in the first compressed image storing section 22 in association with the first hash value and compresses the first compressed image data thus read to generate second compressed image data.

The server device 20 has a higher throughput than the smart phone 10. Therefore, the second image compressing section 26 can compress the first compressed image data by a method having a higher compression ratio than the JPEG, which is preferable. For example, the second image compressing section 26 further compresses the first compressed image data by a method such as JPEG2000, WebP or HEVC-MSP.

The second hash operation section 27 performs a hash operation over the second compressed image data generated by the second image compressing section 26 and calculate a second hash value as a feature amount capable of specifying identity of the second compressed image data. Referring to the hash operation itself in this case, similarly, it is possible to apply a well-known method.

The second feature amount deciding section 28 decides whether the second hash value calculated by the second hash operation section 27 is stored in the client device 30 or not. Specifically, the second feature amount deciding section 28 transmits the second hash value calculated by the second hash operation section 27 to the client device 30 through the communication I/F section 21 and makes an inquiry as to whether the same hash value as the second hash value is stored in the client device 30 or not. Based on a response content transmitted from the client device 30 as a result, then, it is decided whether the second hash value is stored in the client device 30 or not.

Only if the second feature amount deciding section 28 decides that the second hash value is not stored in the client device 30, the second transmitting section 29 transmits the second compressed image data and the second hash value to the client device 30 through the communication I/F section 21. When the second feature amount deciding section 28 makes an inquiry, the second hash value has already been transmitted. For this reason, only the second compressed image data may be transmitted additionally.

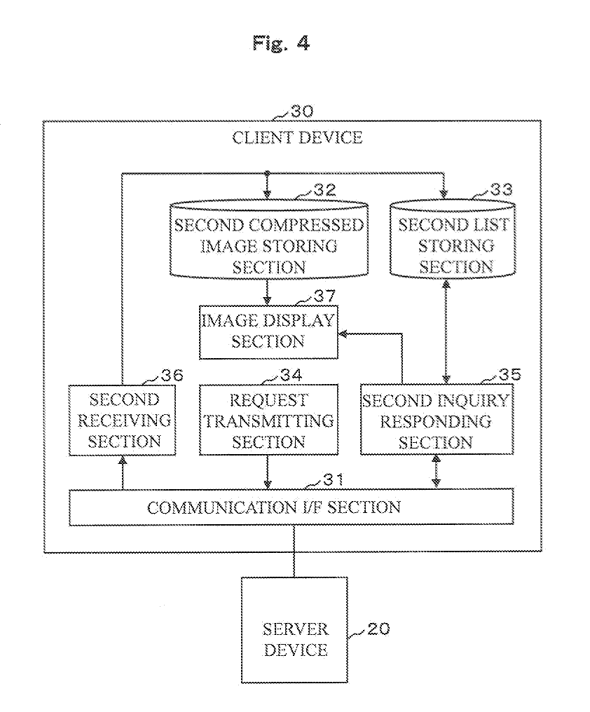

FIG. 4 is a block diagram showing an example of a functional structure of the client device 30 according to the present embodiment. As shown in FIG. 4, the client device 30 according to the present embodiment includes, as a functional structure thereof, a communication I/F section 31, a second compressed image storing section 32, a second list storing section 33, a request transmitting section 34, a second inquiry responding section 35, a second receiving section 36 and an image display section 37.

Each of the function blocks 31 and 34 to 37 can be configured by hardware, DSP or software. For example, in the case in which they are configured by the software, each of the function blocks 31 and 34 to 37 actually includes a CPU, an RAM and an ROM in a computer and the like and a program stored in a recording medium such as the RAM, the ROM, a hard disk or a semiconductor memory is operated so that implementation can be performed.

The communication I/F section 31 serves to carry out communication with the server device 20. The second compressed image storing section 32 stores the second compressed image data transmitted by the second transmitting section 29 of the server device 20. The second list storing section 33 stores, as a second hash list, the second hash value transmitted by the second transmitting section 29.

The request transmitting section 34 transmits the image acquirement request to the smart phone 10 through the internet 40 and the server device 20. The second inquiry responding section 35 carries out processing for responding to an inquiry transmitted from the second feature amount deciding section 28 of the server device 20. In other words, the second inquiry responding section 35 receives the second hash value transmitted from the second feature amount deciding section 28 and confirms whether the second hash value has already been stored in the second list storing section 33. Then, a result of the confirmation as to whether the second hash value is stored is returned to the second feature amount deciding section 28 of the server device 20. Moreover, the second inquiry responding section 35 gives a notice of the result of the confirmation to the image display section 37.

The second receiving section 36 receives the second compressed image data and the second hash value which are transmitted from the second transmitting section 29 of the server device 20. Then, the second receiving section 36 stores the second compressed image data in the second compressed image storing section 32, and furthermore, stores the second hash value in the second list storing section 33. At this time, the second compressed image data and the second hash value are stored in such a configuration that their association is apparent.

The image display section 37 displays, on the screen of the client device 30, the second compressed image data stored in the second compressed image storing section 32. Specifically, the image display section 37 reads the relevant second compressed image data from the second compressed image storing section 32 to carry out display processing depending on a content of a confirmation result given from the second inquiry responding section 35.

In other words, if the second inquiry responding section 35 confirms that the second hash value transmitted from the second feature amount deciding section 28 of the server device 20 is not stored in the second list storing section 33, the second compressed image data and the second hash value are transmitted from the second transmitting section 29 of the server device immediately thereafter and are stored in the second compressed image storing section 32 and the second list storing section 33. In this case, the image display section 37 displays, on the screen, the second compressed image data stored newly in the second compressed image storing section 32. The image display section 37 may directly acquire the second compressed image data received by the second receiving section 36, thereby carrying out the display processing.

On the other hand, if the second inquiry responding section 35 confirms that the second hash value transmitted from the second feature amount deciding section 28 of the server device 20 has already been stored in the second list storing section 33, it is apparent that the second compressed image data corresponding to the second hash value has already been stored in the second compressed image storing section 32. In this case, the image display section 37 reads the second compressed image data stored in the second compressed image storing section 32 in association with the second hash value and displays the second compressed image data thus read on the screen.

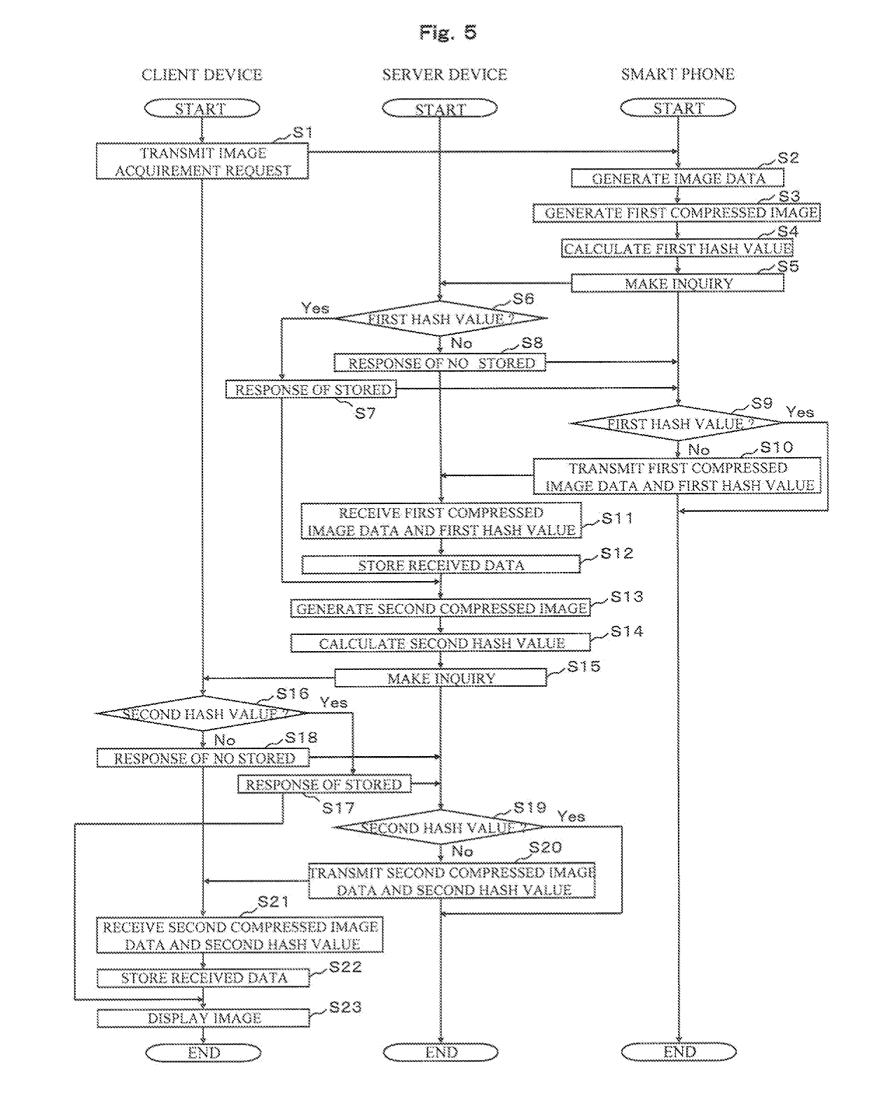

FIG. 5 is a flowchart showing an example of an operation of the image transmission system according to the present embodiment having the structure described above. First of all, the request transmitting section 34 of the client device 30 transmits an image acquirement request to the smart phone 10 through the internet 40 and the server device 20 (Step S1). In the smart phone 10, the image generating section 13 generates image data in response to the image acquirement request upon receipt of the image acquirement request through the request receiving section 12 (Step S2).

Next, the first image compressing section 14 compresses the image data generated by the image generating section 13 to generate first compressed image data (Step S3). Moreover, the first hash operation section 15 carries out a hash operation over the first compressed image data generated by the first image compressing section 14 to calculate a first hash value (Step S4).

The first feature amount deciding section 16 transmits, to the server device 20, the first hash value calculated by the first hash calculating section 15, and makes an inquiry as to whether the same hash value as the first hash value has already been stored in the server device 20 or not (Step S5). The first inquiry responding section 24 of the server device 20 confirms whether the first hash value received by the smart phone 10 has already been stored in the first list storing section 23 (Step S6).

If the first hash value is stored in the first list storing section 23, the first inquiry responding section 24 returns, to the first feature amount deciding section 16 of the smart phone 10, that the first hash value is stored in the first list storing section 23 as a confirmation result for the inquiry, and furthermore, gives a notice to the second image compressing section 26 (Step S7). Then, the processing proceeds to Step S13.

On the other hand, if the first hash value is not stored in the first list storing section 23, the first inquiry responding section 24 returns, to the first feature amount deciding section 16 of the smart phone 10, that the first hash value is not stored in the first list storing section 23 as a confirmation result for the inquiry, and furthermore, gives a notice to the second image compressing section 26 (Step S8).

In the smart phone 10 receiving a response to the inquiry from the server device 20, the first feature amount deciding section 16 decides whether the first hash value is stored in the server device 20 or not based on a content of the response (Step S9). If the first feature amount deciding section 16 decides that the first hash value is stored in the server device 20, nothing is then carried out particularly and the processing in the smart phone 10 is ended.

On the other hand, if the first feature amount deciding section 16 decides that the first hash value is not stored in the server device 20, the first transmitting section 17 transmits the first compressed image data and the first hash value to the server device 20 (Step S10). Consequently, the processing in the smart phone 10 is ended.

In the server device 20, after the response of no storage is given in the Step S8, the first receiving section 25 receives the first compressed image data and the first hash value which are transmitted from the smart phone 10 (Step S11). Then, the first receiving section 25 stores the first compressed image data in the first compressed image storing section 22, and furthermore, stores the first hash value in the first list storing section 23 (Step S12).

Next, the second image compressing section 26 compresses the first compressed image data stored newly in the first compressed image storing section 22 in the Step S12 and generates second compressed image data (Step S13). If a transition is made from the Step S7 to the Step S13, the second image compressing section 26 reads the first compressed image data stored in the first compressed image storing section 22 in association with the first hash value to which an inquiry is made from the first feature amount deciding section 16 of the smart phone 10 without waiting for the first compressed image data to be transmitted from the smart phone 10, and compresses the first compressed image data thus read to generate the second compressed image data.

The second hash operation section 27 carries out a hash operation over the second compressed image data generated by the second image compressing section 26 to calculate a second hash value (Step S14). Then, the second feature amount deciding section 28 transmits the second hash value calculated by the second hash operation section 27 to the client device 30 and makes an inquiry as to whether the same hash value as the second hash value has already been stored in the client device 30 (Step S15).

The second inquiry responding section 35 of the client device 30 confirms whether the second hash value received from the server device 20 has already been stored in the second list storing section 33 (Step S16). If the second hash value is stored in the second list storing section 33, the second inquiry responding section 35 returns, to the second feature amount deciding section 28 of the server device 20, that the second hash value is stored in the second list storing section 33, and furthermore, gives a notice to the image display section 37 (Step S17). Then, the processing proceeds to Step S23.

On the other hand, if the second hash value is not stored in the second list storing section 33, the second inquiry responding section 35 returns, to the second feature amount deciding section 28 of the server device 20, that the second hash value is not stored in the second list storing section 33, and furthermore, gives a notice to the image display section 37 (Step S18).

In the server device 20 receiving the response to the inquiry from the client device 30, the second feature amount deciding section 28 decides whether the second hash value is stored in the client device 30 or not based on the content of the response (Step S19). If the second feature amount deciding section 28 decides that the second hash value is stored in the client device 30, nothing is then carried out particularly and the processing in the server device 20 is ended.

On the other hand, if the second feature amount deciding section 28 decides that the second hash value is not stored in the client device 30, the second transmitting section 29 transmits the second compressed image data and the second hash value to the client device 30 (Step S20). Consequently, the processing in the server device 20 is ended.

In the client device 30, after the response of no storage is given in the Step S18, the second receiving section 36 receives the second compressed image data and the second hash value which are transmitted from the server device 20 (Step S21). Then, the second receiving section 36 stores the second compressed image data in the second compressed image storing section 32, and furthermore, stores the second hash value in the second list storing section 33 (Step S22).

Next, the image display section 37 displays, on the screen of the client device 30, the second compressed image data stored newly in the second compressed image storing section 32 in the Step S22 (Step S23). If a transition is made from the Step S17 to the Step S23, the image display section 37 reads the second compressed image data stored in the second compressed image storing section 32 in association with the second hash value to which an inquiry is made from the second feature amount deciding section 28 of the server device 20 without waiting for the second compressed image data to be transmitted from the server device 20, and displays the second compressed image data thus read on the screen. Consequently, the processing of the flowchart shown in FIG. 5 is ended.

As described above in detail, according to the image transmission system in accordance with the present embodiment, if the first compressed image data generated by the smart phone 10 in response to the image acquirement request given from the client device 30 has already been transmitted from the smart phone 10 to the server device 20 and has been stored in the first compressed image storing section 22 at a time before that, the first compressed image data is not transmitted again from the smart phone 10 to the server device 20 based on a result of the decision using the first hash value.

If the second compressed image data generated by the server device 20 in response to the image acquirement request given from the client device 30 has already been transmitted from the server device 20 to the client device 30 and has been stored in the second compressed image storing section 32 at a time before that, similarly, the second compressed image data is not transmitted again from the server device 20 to the client device 30 based on a result of the decision using the second hash value.

Consequently, it is possible to avoid waste, that is, repetitive transmission of the same image data over two stages between the smart phone 10 and the server device 20 and between the server device 20 and the client device 30, thereby omitting a time taken for the data transmission. For example, in the case in which the same image data acquirement request as before is given from the same client device 30, it is possible to avoid waste, that is, the repetitive transmission of the same image data both between the smart phone 10 and the server device 20 and between the server device 20 and the client device 30.

In the present embodiment, the image transmission system is assumed to be utilized in the remote rental service for the smart phone 10. For this reason, a certain client device 30 acquires certain image data from a certain smart phone 10 and then a request for acquiring the same image data is given from another client device 30 in some cases. In these cases, it is possible to avoid waste, that is, the repetitive transmission of the same image data between the smart phone 10 and the server device 20. Consequently, it is possible to omit the transmission of image data acquired for the first time from the smart phone 10 by another client device 30 between the smart phone 10 and the server device 20, thereby shortening a time taken for the data transmission.

In some cases, moreover, the certain client device 30 might acquire the certain image data from the certain smart phone 10 and a request for acquiring the same image data might be then given from the same client device 30 to another smart phone 10. In these cases, it is possible to avoid waste, that is, the repetitive transmission of the same image data both between the smart phone 10 and the server device 20 and between the server device 20 and the client device 30. Consequently, it is possible to avoid the transmission of image data acquired for the first time from another smart phone 10 by the client device 30 over two stages between the smart phone 10 and the client device 30, thereby shortening a time taken for the data transmission.

According to the image transmission system in accordance with the present embodiment, moreover, the image data is compressed over two stages of the smart phone 10 and the server device 20. Even if the image data is transmitted, it is possible to considerably reduce the data volume of the image data to be transmitted. Consequently, it is possible to shorten the time taken for the data transmission.

As described above, according to the image transmission system in accordance with the present embodiment, the processing for determining whether to transmit the image data and the processing for compressing the image data are carried out over two stages, respectively. Thus, it is possible to shorten a response time as greatly as possible till acquirement of the image data after the client device 30 gives an image acquirement request to the smart phone 10.

Although the description has been given to the example in which the second hash value is used as the feature amount capable of specifying the identity of the second compressed image data in the embodiment, the first hash value may be used. In this case, the second hash operation section 27 of the server device 20 can be omitted and the time taken for calculating the second hash value can further be shortened in association with the response time required till the acquirement of the image data after the output of the image acquirement request to the smart phone 10 by the client device 30.

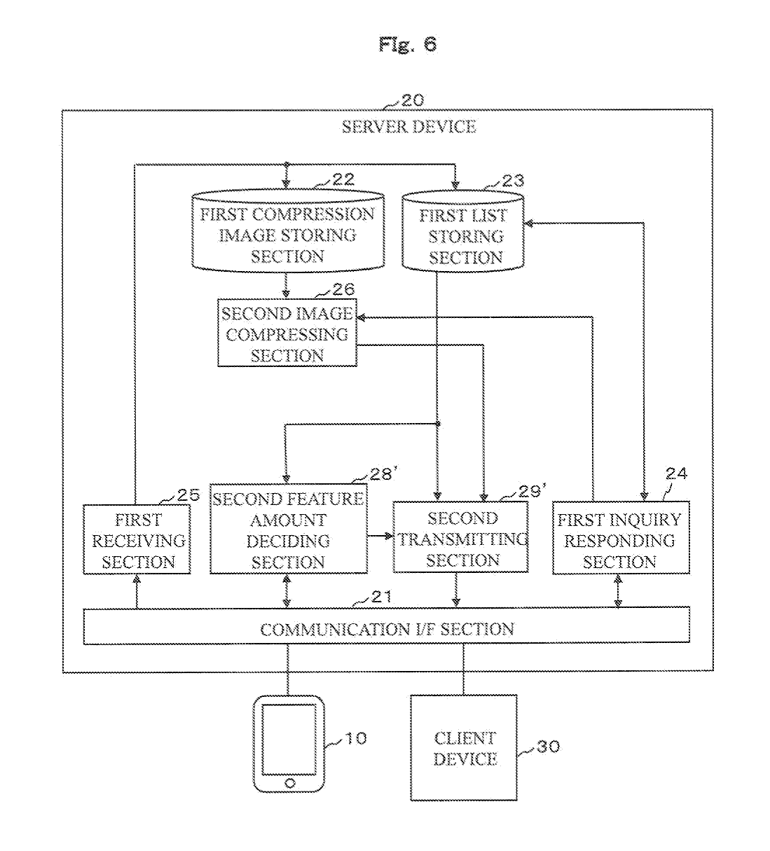

FIG. 6 is a block diagram showing an example of a functional structure of the server device 20 in this case. In the example of the structure in FIG. 6, a second feature amount deciding section 28′ of the server device 20 decides whether the first hash value is stored in the client device 30 as a feature amount capable of specifying the identity of the second compressed image data or not. The first hash value to be used for the decision is stored in the first list storing section 23 in association with the first compressed image data to be a generation source of the second compressed image data.

Only if the second feature amount deciding section 28′ decides that the first hash value is not stored in the client device 30, the second transmitting section 29′ transmits the second compressed image data and the first hash value to the client device 30. Moreover, the second list storing section 33 of the client device 30 stores, as a second hash list, the first hash value transmitted by the second transmitting section 29′ of the server device 20.

Although the description has been given to the example in which the second feature amount deciding section 28 of the server device 20 makes an inquiry to the client device 30 to decide whether the second hash value has already been stored in the client device 30 or not in the embodiment, moreover, the present invention is not restricted thereto. For example, it is also possible to decide whether the second hash value has already been stored in the client device 30 by internal processing of the server device 20 without making an inquiry to the client device 30.

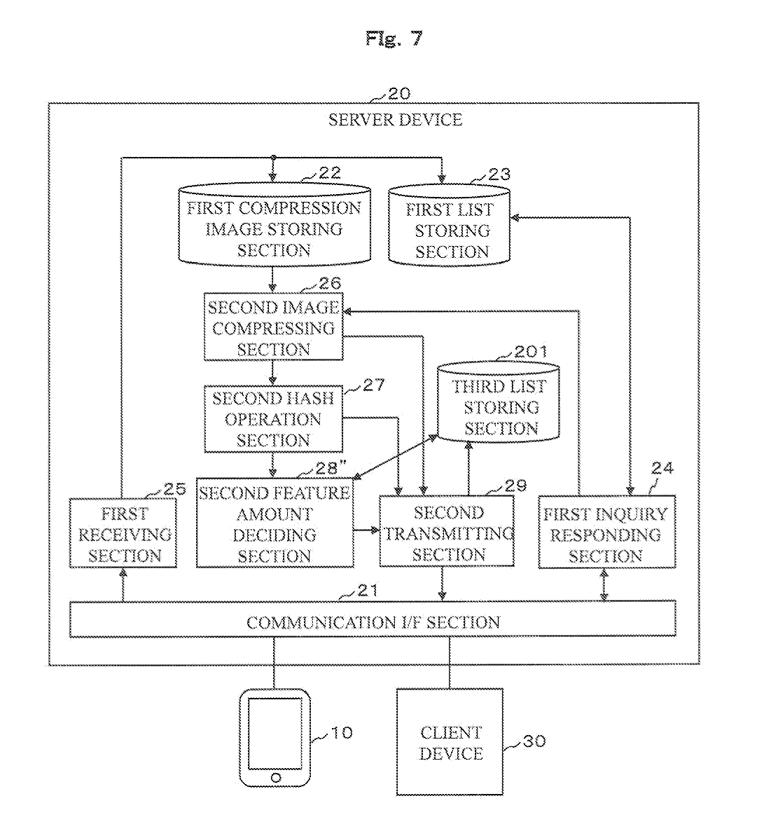

FIG. 7 is a block diagram showing an example of a functional structure of the server device 20 in this case. In the example of the structure in FIG. 7, the server device 20 further includes a third list storing section 201 for storing, as a third hash list, the second hash value transmitted to the client device 30 by the second transmitting section 29. In other words, the server device 20 includes the third list storing section 201 for storing a list of the same second hash value as that of the second list storing section 33 of the client device 30.

A second feature amount deciding section 28″ refers to the third hash list stored in the third list storing section 201, thereby deciding whether the second hash value is stored in the client device 30 or not. By the structure shown in FIG. 7, it is possible to omit a communication time required for making an inquiry to the client device 30 by the server device 20. Therefore, it is possible to further shorten a response time until the image data are acquired after the client device 30 gives an image acquirement request to the smart phone 10.

Similarly, it is also possible to decide whether the first hash value has already been stored in the server device 20 or not by the internal processing of the smart phone 10 without making an inquiry to the server device 20 through the smart phone 10. Referring to the decision as to whether the first hash value has already been stored in the server device 20 or not, however, it is preferable to make an inquiry from the smart phone 10 to the server device 20. The reason is as follows.

The smart phone 10 and the server device 20 are connected to each other by cable, while the server device 20 and the client device 30 are connected to each other through the internet 40. For this reason, a communication time taken for making an inquiry is longer than that between the server device 20 and the client device 30 and is not so long between the smart phone 10 and the server device 20.

In order to decide whether the first hash value has already been stored in the server device 20 or not by the internal processing of the smart phone 10, moreover, it is necessary to store the list of the first hash value in the smart phone 10. However, the smart phone 10 has a smaller memory capacity than the server device 20 and resources to be used are limited.

As described above, preferably, the smart phone 10 makes an inquiry to the server device 20, thereby deciding whether the first hash value is stored in the server device 20 or not, while it is decided whether the second hash value is stored in the client device 30 or not by the internal processing of the server device 20.

It is possible to decide whether the second hash value is stored in the client device 30 or not by the internal processing of the server device 20 in the case in which a second hash list stored in the second list storage section 33 of the client device 30 and a third hash list stored in the third list storing section 201 of the server device 20 have the same contents, that is, the case in which access is given to the server device 20 from the same client device 30. In the case in which the remote rental service for the smart phone 10 is supposed, however, the access is not always given to the server device 20 from the same client device 30.

For example, therefore, the third hash list stored in the third list storing section 201 is divided and managed every different client device 30, and it is decided whether the second hash value is stored in the client device 30 or not by referring to the third hash list related to the client device 30 from which the access is being given. The client device 30 to which the access is being given can be identified by an IP address, for example.

In the example of the structure in FIG. 7, the second hash operation section 27 may be omitted to use the first hash value as a feature amount capable of specifying the identity of the second compressed image data. Consequently, the server device 20 does not need to include the third list storing section 201. In other words, the second feature amount deciding section 28″ can decide whether the first hash value is stored in the client device 30 or not by referring to the first hash list stored in the first list storing section 23.

However, the third list storing section 201 can be omitted in the case in which the second compressed image data generated from the first compressed image data is always transmitted together with the first hash value from the server device 20 to the client device 30 when the first compressed image data is transmitted together with the first hash value from the smart phone 10 to the server device 20. In this case, the first hash list stored in the first list storing section 23 and the third hash list stored in the third list storing section 201 have the same contents.

In the case in which it is supposed that the first hash list to be stored in the first list storing section 23 and the third hash list to be stored in the third list storing section 201 do not have the same contents, the third list storing section 201 is indispensable even if the second hash operation section 27 is omitted and the first hash value is used as the feature amount capable of specifying the identity of the second compressed image data.

For example, in the case in which the communication between the smart phone 10 and the server device 20 and between the server device 20 and the client device 30 is executed asynchronously and the second compressed image data corresponding to a part of the first plural compressed image data to be sequentially transmitted from the smart phone 10 to the server device 20 might not be transmitted from the server device 20 to the client device 30, the third list storing section 201 is indispensable. As this case, for example, it is supposed that a transfer speed between the server device 20 and the client device 30 is lower than a transfer speed between the smart phone 10 and the server device 20.

Although the description has been given to the example in which the second image compressing section 26 always generates the second compressed image data in the embodiment, moreover, the present invention is not restricted. For example, in the case in which the first hash value is used as the feature amount capable of specifying the identity of the second compressed image data as shown in FIG. 6, the second image compressing section 26 may compress the first compressed image data to generate the second compressed image data only if the second feature amount deciding section 28′ decides that the first hash value is not stored in the client device 30.

In the case in which the first hash value is stored in the client device 30 and the second compressed image data does not need to be transmitted from the server device 20 to the client device 30, thus, it is possible to omit the processing itself for generating the second compressed image data. Correspondingly, it is possible to further shorten the response time till the acquirement of the image data after the client device 30 gives the image acquirement request to the smart phone 10.

Although the description has been given to the example in which the second image compressing section 26 reads and compresses the first compressed image data stored in the first compressed image storing section 22 in association with the first hash value, thereby generating the second compressed image data in the case in which the first hash value to which the inquiry is made from the smart phone 10 has already been stored in the first list storing section 23 in the embodiment, moreover, the present invention is not restricted thereto.

For example, in the case in which the first hash value to which the inquiry is made from the smart phone 10 is not stored in the first list storing section 23, the second compressed image data is saved in the server device 20 when the second image compressing section 26 compresses the first compressed image data transmitted from the smart phone 10 and first generates the second compressed image data. After a second time that it is decided that the first hash value to which the inquiry is made from the smart phone 10 has already been stored in the first list storing section 23, then, it is also possible to enable the generation of the second compressed image data to be omitted by utilizing the second compressed image data saved in the server device 20 to calculate the second hash value.

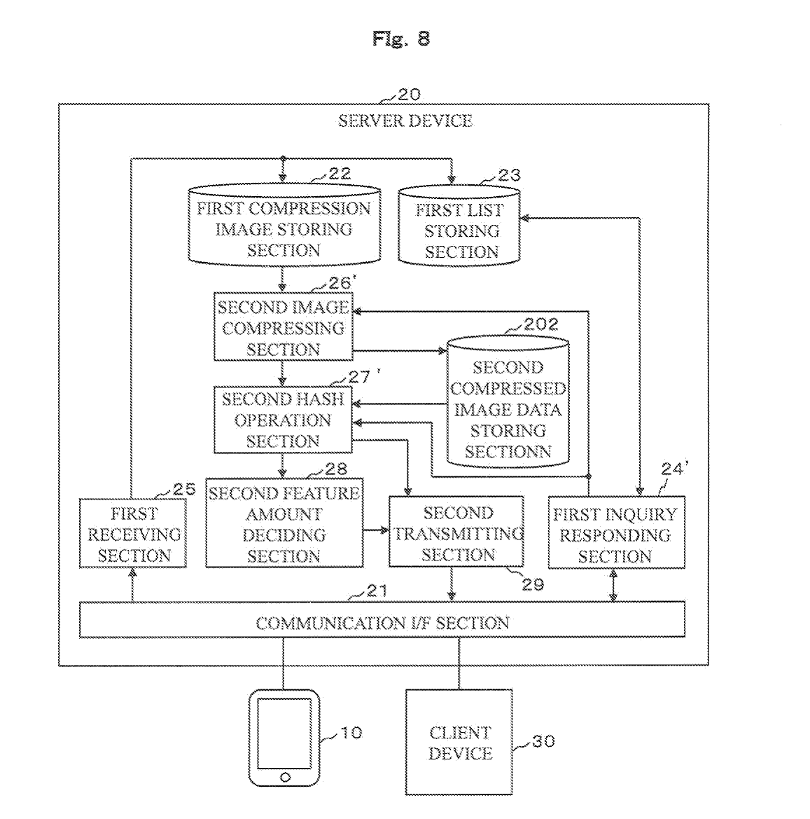

FIG. 8 is a block diagram showing an example of a functional structure of the server device 20 in this case. In the example of the structure in FIG. 8, the server device 20 includes a first inquiry responding section 24′, a second image compressing section 26′ and a second hash operation section 27′ in place of the first inquiry responding section 24, the second image compressing section 26 and the second hash operation section 27 shown in FIG. 3. Moreover, a second compressed image data storing section 202 is further provided.

The first inquiry responding section 24′ returns, to the first feature amount deciding section 16 of the smart phone 10, a result of the decision as to whether the first hash value transmitted from the smart phone 10 is stored in the first list storing section 23 as a result of confirmation in response to the inquiry, and furthermore, gives a notice to the second image compressing section 26′ and the second hash operation section 27′.

In the case in which the first inquiry responding section 24′ gives a notice that the first hash value is not stored in the first list storing section 23, the second image compressing section 26′ generates the second compressed image data from the first compressed image data transmitted from the smart phone 10 and stores the second compressed image data in the second compressed image data storing section 202 in association with the first hash value. Moreover, the second hash operation section 27′ carries out the hash operation over the second compressed image data generated by the second image compressing section 26′, thereby calculating a second hash value.

On the other hand, in the case in which the first inquiry responding section 24′ gives a notice that the first hash value is stored in the first list storing section 23, the second image compressing section 26′ does not carry out the processing for generating the second compressed image data. Moreover, the second hash operation section 27′ reads the second compressed image data stored in the second compressed image data storing section 202 in association with the first hash value and carries out the hash operation over the second compressed image data thus read, thereby calculating the second hash value. In the case in which this structure is employed, the processing makes a transition from the Step S7 to the Step S14 in the flowchart of FIG. 5.

Although the description has been given to the example in which the second compressed image data is saved in the server device 20 and can be utilized after the second time, it is also possible to omit the operation for the second hash value after the second time by saving the second hash value together with the second compressed image data in the server device 20. In this case, the processing makes a transition from the Step S7 to the Step S15 in the flowchart of FIG. 5.

In the case in which the structure is employed as shown in FIG. 8, the generation of the second compressed image data (and the operation for the second hash value) can be omitted after the second time that it is decided that the first hash value to which an inquiry is made from the smart phone 10 has already been stored in the first list storing section 23. Therefore, it is possible to further shorten the response time till the acquirement of the image data after the client device 30 gives the image acquirement request. By applying the structure shown in FIG. 7 and the structure shown in FIG. 8 in combination, it is also possible to shorten the response time still more.

Although the description has been given to the example in which the image transmission system is applied to the remote rental service for the smart phone 10 in the embodiment, moreover, the present invention is not restricted thereto. In other words, it is possible to apply the present invention to any image transmission system configured to transmit image data generated by an image generation device in response to an image acquirement request output from a client device from a server device to the client device.

Although the description has been given to the example in which the server device 20 and the client device 30 are connected to each other through the internet 40 in the embodiment, the present invention is not restricted thereto. For example, it is possible to connect the server device 20 and the client device 30 through every communication network regardless of cable/wireless, LAN/WAN or the like.

Although the description has been given to the example in which the first image compressing section 14 compresses an image by the JPEG method and the second image compressing section 26 compresses an image by the method of the JPEG2000, the WebP, the HEVC-MSP or the like in the embodiment, moreover, the present invention is not restricted thereto. In other words, it is sufficient that a processing load for the execution of the image compression is smaller in the first image compressing section 14 than that in the second image compressing section 26 and the compressing method is not particularly restricted. Moreover, the same compressing method may be applied to the first image compressing section 14 and the second image compressing section 26 and the processing load may be reduced more greatly in the first image compressing section 14 than the second image compressing section 26 by regulating a compression parameter.

In addition, the embodiment is only illustrative for concreteness to carry out the present invention and the technical scope of the present invention should not be thereby construed to be restrictive. In other words, the present invention can be carried out in various configurations without departing from the gist or main features thereof.

### EXPLANATION OF DESIGNATION

10 smart phone (image generation device)

13 image generating section

14 first image compressing section

15 first hash operation section

16 first feature amount deciding section

17 first transmitting section

20 server device

22 first compressed image storing section

23 first list storing section

26, 26′ second image compressing section

27, 27′ second hash operation section

28, 28′, 28″ second feature amount deciding section

29, 29′ second transmitting section

201 third list storing section

202 second compressed image data storing section

30 client device

32 second compressed image storing section

33 second list storing section

1. An image transmission system having an image generation device, a server device connected to the image generation device, and a client device connected to the server device, image data generated by the image generation device in response to an image acquirement request output from the client device being transmitted from the server device to the client device,
the image generation device comprising:
an image generating section for generating image data in response to the image acquirement request transmitted from the client device via the server device;
a first image compressing section for compressing the image data generated by the image generating section to generate first compressed image data;
a first feature amount deciding section for deciding whether a feature amount capable of specifying identity of the first compressed image data generated by the first image compressing section is stored in the server device or not; and
a first transmitting section for transmitting the first compressed image data and the feature amount to the server device only if the first feature amount deciding section decides that the feature amount capable of specifying the identity of the first compressed image data is not stored in the server device,
the server device comprising:
a first compressed image storing section for storing the first compressed image data transmitted by the first transmitting section;
a first list string section for storing the feature amount transmitted by the first transmitting section as a first list;
a second image compressing section for compressing the first compressed image data stored in the first compressed image storing section to generate second compressed image data;
a second feature amount deciding section for deciding whether a feature amount capable of specifying identity of the second compressed image data generated by the second image compressing section is stored in the client device; and
a second transmitting section for transmitting the second compressed image data and the feature amount to the client device only if the second feature amount deciding section decides that the feature amount capable of specifying the identity of the second compressed image data is not stored in the client device, and
the client device comprising:
a second compressed image storing section for storing the second compressed image data transmitted by the second transmitting section; and
a second list storing section for storing, as a second list, the feature amount transmitted by the second transmitting section.

2. The image transmission system according to claim 1, wherein the image generation device further includes a first hash operation section for carrying out a hash operation over the first compressed image data generated by the first image compressing section and calculating a first hash value as a feature amount capable of specifying identity of the first compressed image data,
the first feature amount deciding section decides whether the first hash value calculated by the first hash operation section is stored in the server device or not,
the first transmitting section transmits the first compressed image data and the first hash value to the server device only if the first feature amount deciding section decides that the first hash value is not stored in the server device,
the server device further includes a second hash operation section for carrying out a hash operation over the second compressed image data generated by the second image compressing section and calculating a second hash value as a feature amount capable of specifying identity of the second compressed image data,
the first list storing section stores the first hash value transmitted by the first transmitting section as a first hash list,
the second feature amount deciding section decides whether the second hash value, as a feature amount capable of specifying the identity of the second compressed image data, is stored in the client device or not;
the second transmitting section transmits the second compressed image data and the second hash value to the client device only if the second feature amount deciding section decides that the second hash value is not stored in the client device, and
the second list storing section of the client device stores the second hash value transmitted by the second transmitting section as a second hash list.

3. The image transmission system according to claim 1, wherein the image generation device further includes a first hash operation section for carrying out a hash operation over the first compressed image data generated by the first image compressing section and calculating a first hash value as a feature amount capable of specifying identity of the first compressed image data,
the first feature amount deciding section decides whether the first hash value calculated by the first hash operation section is stored in the server device or not,
the first transmitting section transmits the first compressed image data and the first hash value to the server device only if the first feature amount deciding section decides that the first hash value is not stored in the server device,
the first list storing section of the server device stores the first hash value transmitted by the first transmitting section as a first hash list,
the second feature amount deciding section decides whether the first hash value, as a feature amount capable of specifying the identity of the second compressed image data, is stored in the client device or not,
the second transmitting section transmits the second compressed image data and the first hash value to the client device only if the second feature amount deciding section decides that the first hash value is not stored in the client device, and
the second list storing section of the client device stores the first hash value transmitted by the second transmitting section as a second hash list.

4. The image transmission system according to claim 2, wherein the server device further includes a third list storing section for storing, as a third hash list, the second hash value transmitted to the client device by the second transmitting section, and
the second feature amount deciding section refers to the third hash list, thereby deciding whether the second hash value is stored in the client device or not.

5. The image transmission system according to claim 3, wherein the second image compressing section compresses the first compressed image data to generate second compressed image data only if the second feature amount deciding section decides that the first hash value, as a feature amount capable of specifying the identity of the second compressed image data, is not stored in the client device.
